(19) United States
(12) Patent Application Publication
(10) Pub. No.: US 2019/0010790 A1
(43) Pub. Date: Jan. 10, 2019

(54) MULTI-PARAMETER OPTIMIZATION OF OILFIELD OPERATIONS

(71) Applicant: Halliburton Energy Services, Inc., Houston, TX (US)

(72) Inventors: Stanley V. Stephenson, Duncan, OK (US); Richard T. Gonzalez, Houston, TX (US); Dwight D. Fulton, Cypress, TX (US); Harold G. Walters, Tomball, TX (US); Jon M. Orth, Denver, CO (US); Kenneth R. Coffman, Duncan, OK (US)

(21) Appl. No.: 16/081,528

(22) PCT Filed: May 6, 2016
(86) PCT No.: PCT/US2016/031346

§ 371 Date: Aug. 31, 2018

(51) Int. Cl. E21B 41/00; G05B 13/04

(52) U.S. Cl. CPC E21B 41/0092; G05B 13/041

(57) ABSTRACT

A method for optimizing oilfield operations, in some embodiments, comprises: identifying a first oilfield model; determining n solutions to the first oilfield model that optimize a target parameter of the first oilfield model; identifying a second oilfield model; identifying a set of parameter values used in then solutions; selecting from said set a value that optimizes a different target parameter in the second oilfield model; determining an optimal solution to the first oilfield model using the selected value as a constant in said first oilfield model; and adjusting oilfield equipment using one or more of said optimizations.

### BACKGROUND

Oilfield services firms are frequently retained to handle projects that require specified criteria to be met when designing and completing the projects. Many such projects can be designed and performed as requested. However, the specified criteria often restrict project parameters that have an effect on other parameters, and such secondary effects must be considered when designing the project. For instance, stipulating that very high fluid pressures be used in a well for extended periods of time will have a significant impact on fluid costs. In some cases, this impact is so substantial that the project would be better completed at lower pressure, for a shorter period of time, or both. Identifying the optimal balance of pressure, time, and cost (and, more generally, the optimal balance of multiple parameters in any oilfield project) remains a challenge.

### BRIEF DESCRIPTION OF THE DRAWINGS

FIG. 1 is a schematic diagram of a drilling environment.

FIG. 2 is a schematic diagram of a wireline environment.

FIG. 3 is a block diagram of a computer system to implement the techniques described herein.

FIGS. 4-5 are flow diagrams illustrating various techniques for optimizing multiple parameters in an oilfield project.

### DETAILED DESCRIPTION

Disclosed herein are various techniques for optimizing multiple parameters in an oilfield operation. In general, the techniques entail identifying several models pertaining to the oilfield project, identifying n optimal solutions for one of the models, and then inserting a set of parameter values identified in those n solutions into a different model in an attempt to determine m optimal solutions for that model. This is an iterative process that is repeated until the last model is reached, at which point a single optimal solution for the last model is determined. One or more of the parameter values used in that single optimal solution may then be used as constants in any of the previous models to again determine optimal solutions in those previous models. The optimizations can then be used as desired—for instance, to control oilfield equipment. In this way, each of the previous models is optimized while taking into account the optimizations achieved for other target parameters using the other models. As a result, multiple parameters are simultaneously and optimally balanced.

This concept may best be explained in the context of an illustrative example Each oilfield model contains a target parameter to be optimized and multiple variable parameters that may be adjusted to achieve such optimization. For example, three such models may be identified, with each of the three models containing a different target parameter (e.g., fluid pressure, sound emissions, cost) to be optimized. The models are ranked from first to last in order of the priority of their respective target parameters. For instance, if cost is most important, it is ranked as the first model; similarly, if sound emission is the least important, it is ranked as the last model.

Values for all parameters in the model that will optimize the target parameter for that model are determined. This set of values is called a “solution,” and several such solutions may be identified for the first model. The first and second models will have one or more parameters in common. The values identified for these common parameters in the solutions to the first model are subsequently used in the second model to optimize the target parameter for that model. Several solutions to the second model may be identified in this way. Because some of the parameters in the second and third models will overlap, the values identified for these common parameters in the solutions to the second model are then used in the third model to optimize the target parameter for that model. A single optimal solution is identified for the third model. One or more of the parameter values used in that single solution may then be used in the first model (or, if desired, in the second model) as constants while the remaining parameters in the first model are varied until an optimal solution to the first model is determined. That optimal solution to the first model accounts not just for the target parameter of the first model, but it also accounts for the target parameters of the second and third models. In this way, multiple parameters of interest can be balanced to determine an optimal overall solution. The optimal solution to the first model may then be used to control or otherwise adjust oilfield equipment, as desired. These techniques are described in greater detail below.

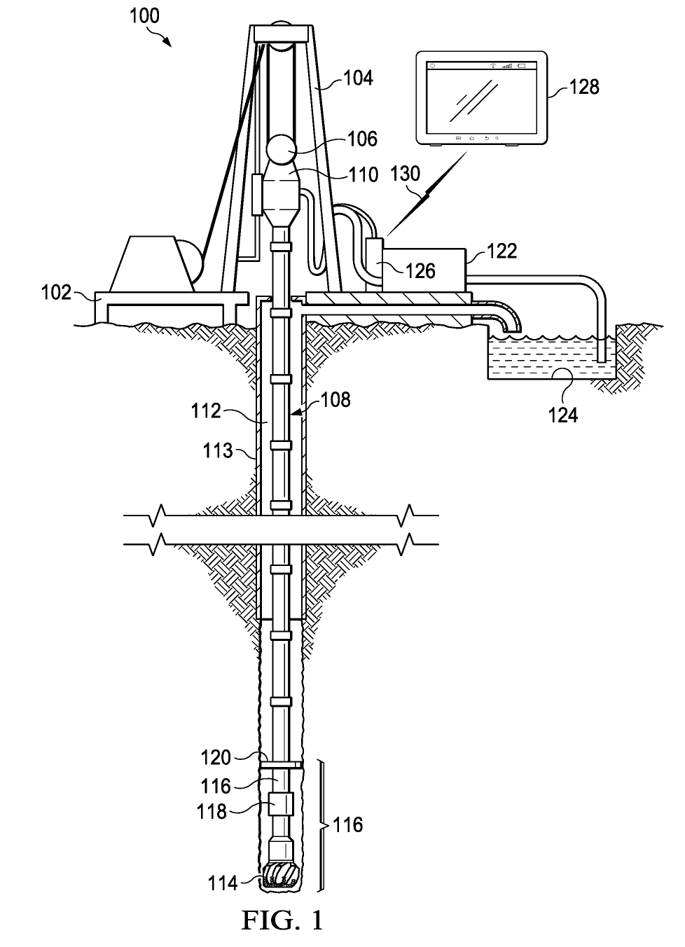

FIG. 1 is a schematic diagram of an illustrative drilling environment 100. The drilling environment 100 comprises a drilling platform 102 that supports a derrick 104 having a traveling block 106 for raising and lowering a drill string 108. A top-drive motor 110 supports and turns the drill string 108 as it is lowered into a borehole 112. The drill string's rotation, alone or in combination with the operation of a downhole motor, drives the drill bit 114 to extend the borehole 112. The drill bit 114 is one component of a bottomhole assembly (BHA) 116 that may further include a rotary steering system (RSS) 118 and stabilizer 120 (or some other form of steering assembly) along with drill collars and logging instruments. A pump 122 circulates drilling fluid through a feed pipe to the top drive 110, downhole through the interior of drill string 108, through orifices in the drill bit 114, back to the surface via an annulus around the drill string 108, and into a retention pit 124. The drilling fluid transports formation samples—i.e., drill cuttings—from the borehole 112 into the retention pit 124 and aids in maintaining the integrity of the borehole. Formation samples may be extracted from the drilling fluid at any suitable time and location, such as from the retention pit 124. The formation samples may then be analyzed at a suitable surface-level laboratory or other facility (not specifically shown). While drilling, an upper portion of the borehole 112 may be stabilized with a casing string 113 while a lower portion of the borehole 112 remains open (uncased).

The drill collars in the BHA 116 are typically thick-walled steel pipe sections that provide weight and rigidity for the drilling process. The BHA 116 typically further includes a navigation tool having instruments for measuring tool orientation (e.g., multi-component magnetometers and accelerometers) and a control sub with a telemetry transmitter and receiver. The control sub coordinates the operation of the various logging instruments, steering mechanisms, and drilling motors, in accordance with commands received from the surface, and provides a stream of telemetry data to the surface as needed to communicate relevant measurements and status information. A corresponding telemetry receiver and transmitter is located on or near the drilling platform 102 to complete the telemetry link. One type of telemetry link is based on modulating the flow of drilling fluid to create pressure pulses that propagate along the drill string (“mud-pulse telemetry or MPT”), but other known telemetry techniques are suitable. Much of the data obtained by the control sub may be stored in memory for later retrieval, e.g., when the BHA 116 physically returns to the surface.

A surface interface 126 serves as a hub for communicating via the telemetry link and for communicating with the various sensors and control mechanisms on the platform 102. A data processing unit (shown in FIG. 1 as a tablet computer 128) communicates with the surface interface 126 via a wired or wireless link 130, collecting and processing measurement data to generate logs and other visual representations of the acquired data and the derived models to facilitate analysis by a user. The data processing unit may take many suitable forms, including one or more of: an embedded processor, a desktop computer, a laptop computer, a central processing facility, a distributed processor, and a virtual computer in the cloud. In each case, software on a non-transitory information storage medium may configure the processing unit to carry out the desired processing, modeling, and display generation. The data processing unit may also contain storage to store, e.g., data received from tools in the BHA 116 via mud pulse telemetry or any other suitable communication technique. The scope of disclosure is not limited to these particular examples of data processing units. Additional processor(s) and/or storage containing executable software code may be included, for instance, in appropriate portions of the drill string 108. Any or all of the foregoing processor(s) and/or storage containing software may be used to perform one or more of the techniques described herein. Further, any and all variations and equivalents of the foregoing processors and software-containing storage are contemplated and fall within the scope of this disclosure.

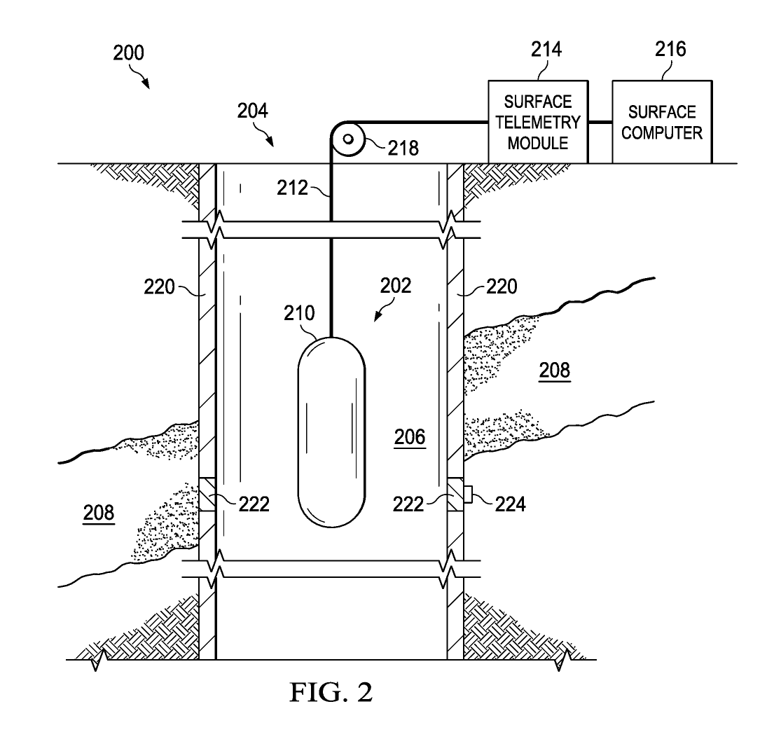

FIG. 2 is a schematic diagram of a wireline environment. More specifically, FIG. 2 illustrates a logging system 200 that comprises a wireline logging tool 202 disposed within a borehole 204 proximate to a formation 208 of interest. The borehole 204 contains a casing string 220 and casing fluid 206, which may comprise one or more of oil, gas, fresh water, saline water, or other substances. Receivers may be mounted on such a casing string 220. The tool 202 comprises a sonde 210 within which various subsystems of the tool 202 reside. These subsystems are equipped to measure various parameters associated with the formation and wellbore. In the illustrative case of FIG. 2, the sonde 210 is suspended within the borehole 204 by a cable 212. Cable 212, in some embodiments a multi-conductor armored cable, not only provides support for the sonde 210, but also in these embodiments it communicatively couples the tool 202 to a surface telemetry module 214 and a surface computer 216. The tool 202 may be raised and lowered within the borehole 204 by way of the cable 212, and the depth of the tool 202 within the borehole 204 may be determined by depth measurement system 218 (illustrated as a depth wheel). The casing string 220 may be composed of multiple segments of casing that are joined using casing collars, such as collar 222. In some embodiments, tools (e.g., electrodes, logging equipment, and communication equipment including fiber optics and transmitters and/or receivers) may be included within, coupled to or adjacent to the casing string 220 and/or the collar 222. For example, FIG. 2 includes a transceiver 224 that functions as a transmitter, receiver or both and communicates with other transmitters or receivers in other parts of the borehole 204, within the sonde 210 or at the surface. The surface computer 216 includes one or more processors and one or more storage systems storing software code that may be executed to perform one or more of the techniques described herein. These techniques also may be executed by processors and software code stored in other areas, such as within the sonde 210, remotely from the wireline environment of FIG. 2, or in a distributed fashion. Any and all such variations and equivalents are contemplated and fall within the scope of this disclosure.

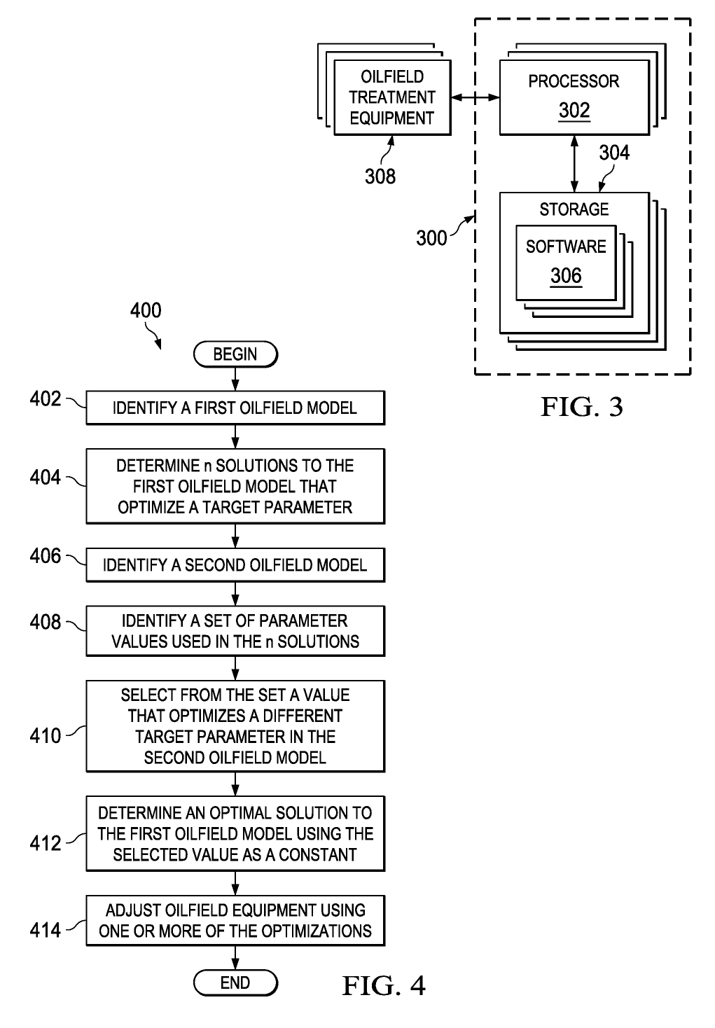

FIG. 3 is a block diagram of an illustrative computer system 300 to implement the techniques described herein. The system 300 comprises a processor 302 and storage 304 storing software 306. As alluded above, the processor 302 may be any suitable type of processor and may be positioned in any suitable location, including within a drill string, in a wireline sonde, at the surface of a well, and/or in other remote locations. The processor 302, in some embodiments, is distributed in nature. Similarly, the storage 304 may be located within a drill string, in a wireline sonde, at the surface of a well, and/or in other remote locations. As with the processor, the storage 304 may be located in multiple locations (e.g., in a distributed fashion). Similarly, the software code 306 may be in a single location or distributed over multiple locations. All such variations and equivalents are included within the scope of this disclosure.

Still referring to FIG. 3, the computer system 300 couples to oilfield equipment 308. Virtually all types of petroleum industry equipment qualify as “oilfield equipment,” and they can include, without limitation, drilling equipment; logging equipment; wireline equipment; fluid equipment; chemical equipment; computer equipment; transmitter and receiver equipment; seismic equipment; acquisitions and shipping equipment; clerical and billing equipment; and any and all other types of equipment that fall within the purview of oilfield services firms and oil production companies. The computer system 300 and, more specifically, the processor 302 controls or influences the operation of one or more instances of oilfield equipment 308 as a result of executing software 306, as described below. For example, as a result of performing one or more of the techniques described herein, the processor 302 may cause fluid pressure in a drilling operation to decrease, or the processor 302 may cause the concentration of a particular chemical in a fluid system to increase.

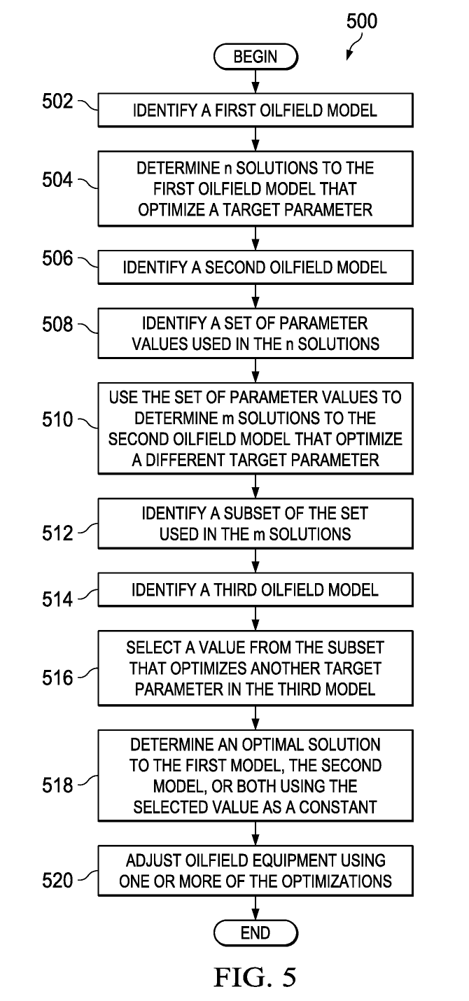

FIG. 4 is a flow diagram illustrating a method 400 for optimizing multiple target parameters in an oilfield project. The steps of the method 400 are performed by, e.g., the processor 302 of FIG. 3 that may be located in any suitable location—for example, in the drill string of FIG. 1 or the sonde of FIG. 2. The processor performs these steps as a result of executing the software 306. The method 400 begins with identifying a first oilfield model (step 402). This oilfield model, as well as any other oilfield model described herein, is any model that describes an aspect of oilfield services or oil production companies. This includes, without limitation, their upstream and/or downstream petroleum operations and their management and business operations. The model has numerous parameters, at least one of which is a target parameter (e.g., revenue per barrel of oil equivalent, sound emissions) that is to be optimized in this method. Adjusting the value of one or more such parameters in the model may result in the alteration of the value of one or more other parameters in the model. For example, in some embodiments, increasing fluid pressure will increase cost, and increasing weight-on-bit will decrease total drilling time. An illustrative first oilfield model may be:

X₁+X₂+X₃+X₄+X₅=TARGET₁ (1)

In this first model, X₁-X₅ and TARGET₁ are parameters, and TARGET₁ is the target parameter.

The method 400 next comprises determining n solutions to the first oilfield model that optimize the target parameter (step 404). The value of n may be set as desired. In the running example, n=3. Further, a “solution” is defined as a set of parameter values for a model. Thus, for instance, an illustrative solution to the model in (1) may be {X₁=1, X₂=3, X₃=5, X₄=7, X₅=9, TARGET₁=25}. Finally, to “optimize” a parameter within a model means to determine a solution that achieves a predetermined target value for that parameter or to determine a solution that comes closest to achieving that predetermined target value. For purposes of this disclosure and the claims, a predetermined target value need not always be precisely specified. For instance, a predetermined target value for a parameter may in some applications be defined as “the highest possible value” of that parameter or “the lowest possible value” of that parameter. In some instances, multiple solutions may “optimize” a parameter of a model, if those multiple solutions all meet the predetermined target value, all come equally close to meeting the predetermined target value, or all exceed a predetermined threshold value. In some instances, n solutions optimize a parameter of a model if those n solutions are the solutions that meet or come closest to meeting the predetermined target value compared to all other possible solutions. Solutions to some or all models in this disclosure are determined using one or more genetic algorithms Any suitable genetic algorithm(s) may be used.

Because n=3 in the running example, illustrative solutions that optimize TARGET₁ in the first model may include:

{X₁=1, X₂=3, X₃=5, X₄=7, X₅=9, TARGET_{=25}}

{X₁=2, X₂=4, X₃=4, X₄=6, X₅=9, TARGET₁=25}

{X₁=3, X₂=5, X₃=3, X₄=5, X₅=9, TARGET₁=25} (2)

The method 400 then comprises identifying a second oilfield model (step 406). An illustrative model may be:

X₁+X₂+X₆+X₇+X₈=TARGET₂ (3)

The method 400 next includes identifying a set of parameter values used in the n solutions to the first model (step 408). More specifically, all values used in the n solutions for parameters that are common to the two selected models are identified. In the running example, the second model includes X₁ and X₂ but not X₃, X₄ or X₅. Thus, in step 408, the ranges of values for parameters X₁ and X₂ are identified—specifically, {X₁: 1-3} and {X₂: 3-5}.

The method 400 subsequently includes selecting from the set a value that optimizes a target parameter in the second oilfield model (step 410). In some embodiments, the target parameter of the second model has a lower priority level than the target parameter of the first model. In the running example, values between 1-3 and between 3-5 are identified for X₁ and X₂, respectively, that optimize TARGET₂ in the second model. Thus, for instance, the values X₁=1 and X₂=5 may be identified as the values that optimize TARGET₂ in the second model (optimal value for TARGET₂ being 10):

{X₁=3, X₂=5, X₆=1, X₇=1, X₈=2, TARGET₂=10} (4)

Note that using different values for X₁ from the range 1-3 and/or different values for X₂ from the range 3-5 may not necessarily result in a TARGET₂ value of 10, since different values for X₁ and/or X₂ can affect X₆-X₈ in different (and potentially non-linear) ways.

The method 400 next includes determining an optimal solution to the first oilfield model using the selected value as a constant (step 412). In the running example, X₁=1 and X₂=5 are used as constants in the first model:

{X₁=3, X₂=5, X₃=10, X₄=8, X₅=1, TARGET₁=25} (5)

Finally, the method 400 includes adjusting oilfield equipment using one or more of the optimizations described in the method 400 (step 414). For example, the final solution for the first model (as described with respect to step 412) may be used to determine various equipment settings. The method is then complete. The method 400 may be modified as desired, including by adding, deleting or modifying individual steps.

FIG. 5 is a flow diagram of a method 500 for optimizing multiple parameters in an oilfield project. It differs from the method 400 in that it is directly applicable to situations in which there are three or more models being used. The method 500 begins with identifying a first oilfield model (step 502). In the running example, (1) is the first model. The method 500 then comprises determining n solutions to the first model that optimize a target parameter (step 504). The target parameter in the first model is TARGET₁, and, assuming that n=3, the solutions are provided in (2). A second oilfield model is identified (step 506). The method 500 then includes identifying a set of parameter values used in the n solutions to the first model (step 508). In the running example, if parameters X₁ and X₂ from the first model are found in the second model but the remaining parameters of the first model are not, then values for Xi and X₂ are determined. Illustrative values may be {X₁: 1-3} and {X₂: 3-5}. The method 500 comprises using the set of parameter values to determine m solutions to the second model that optimize a target parameter TARGET₂ (step 510), which, in some embodiments, has a lower priority level than the target parameter of the first model. (In this disclosure, m will typically be less than or equal to n.) Thus, in the running example, (3) is the second model, and assuming m=2 and that an optimal value for TARGET₂ is 10, illustrative solutions to the second model may be:

{X₁=1, X₂=5, X₃=1, X₄=1, X₅=2, TARGET₂=10}

{X₁=3, X₂=3, X₆=1, X₇=2, X₈=1, TARGET₂=10} (6)

As shown, the values for X₁ and X₂—which are the parameters the first and second models have in common—are selected from the sets that were obtained from the n solutions to the first model. The remaining values X₆-X₈ may be varied to obtain the optimal value for target parameter TARGET₂.

The method 500 then comprises identifying those values of the common parameters (e.g., X₁, X₂) that were used in the second model (step 512). For instance, in (6), X₁ values were {X₁: 1,3} and X₂ values were {X₂: 5, 3}. The method 500 then includes identifying a third model (step 514) and selecting a value from the subset identified in step 512 that optimizes the target parameter in the third model (step 516). (In some embodiments, the target parameter for the third model has a lower priority level than the target parameter for the first model, the second model, or both.) For instance, assume the third model is as follows:

X₁+X₂+X₉+X₁₀=TARGET₃ (7)

Further assume that the optimal value for TARGET₃ is 10. Accordingly, an illustrative execution of step 516 may be as follows:

{X₁=1, X₂=3, X₉=2, X₁₀=2, TARGET₃=8} (8)

As shown in (8), the X₁ value of 1 is selected from the set {X₁: 1, 3} and the X₂ value of 3 is selected from the X₂ range of {X₂: 5, 3}. The remaining parameters X₉ and X₁₀ of the third model are varied until the value for TARGETS that is as close as possible to the optimal value of 10 is achieved—in this case, 8.

The method 500 subsequently comprises determining an optimal solution to the first model, the second model, or both using the selected value as a constant (step 518). In the running example, the selected values for the parameters X₁ and X₂ were 1 and 3, respectively. These values may be used as constants in the first and/or second models while the remaining parameters in each of those models is varied until the target parameters reach values that are as close as possible to the optimal value. The resulting solutions for the first and/or second models may then be used as desired to, e.g., adjust oilfield equipment (step 520). The method 500 may be adjusted as desired, including by adding, deleting or modifying steps.

Numerous other variations and modifications will become apparent to those skilled in the art once the above disclosure is fully appreciated. It is intended that the following claims be interpreted to embrace all such variations, modifications and equivalents. In addition, the term “or” should be interpreted in an inclusive sense.

In at least some embodiments, a method for optimizing oilfield operations comprises: identifying a first oilfield model; determining n solutions to the first oilfield model that optimize a target parameter of the first oilfield model; identifying a second oilfield model; identifying a set of parameter values used in the n solutions; selecting from said set a value that optimizes a different target parameter in the second oilfield model; determining an optimal solution to the first oilfield model using the selected value as a constant in said first oilfield model; and adjusting oilfield equipment using one or more of said optimizations. These embodiments may be supplemented using one or more of the following concepts, in any order and in any combination: wherein the n solutions either optimize the target parameter equally or optimize the target parameter unequally but beyond a predetermined optimization threshold; wherein the oilfield operations include upstream and downstream petroleum operations; wherein selecting said value that optimizes the different target parameter comprises varying one or more other parameters of the second oilfield model; wherein determining said n solutions comprises using a genetic algorithm; wherein determining said optimal solution comprises varying one or more other parameters of the first oilfield model while holding said selected value constant; wherein the target parameter has a higher priority than said different target parameter; and wherein the target parameter is revenue per barrel of oil equivalent (BOE) and the different target parameter is the degree of sound emissions.

In some embodiments, a method comprises: identifying a first oilfield model; determining n solutions to the first oilfield model that optimize a target parameter of the first oilfield model; identifying a second oilfield model; identifying a set of parameter values used in the n solutions; using said set of parameter values to determine m solutions to the second oilfield model that optimize a different target parameter of the second oilfield model; identifying a third oilfield model; identifying a subset of said set used in the m solutions; selecting a value from said subset, said selected value optimizes another target parameter in the third oilfield model; determining an optimal solution to the first oilfield model, the second oilfield model, or both using the selected value as a constant; and adjusting oilfield equipment using one or more of said optimizations. At least some of these embodiments may be supplemented using one or more of the following concepts, in any order and in any combination: wherein the target parameter has a higher priority than said different target parameter, and said different target parameter has a higher priority than said another target parameter; wherein m is less than or equal to n; wherein determining said n solutions and m solutions comprises using genetic algorithms; wherein the n solutions optimize the target parameter equally; and wherein the n solutions optimize the target parameter unequally but beyond a predetermined optimization threshold.

In some embodiments, a computer-readable medium storing software which, when executed by a processor, causes the processor to: identify a first oilfield model; determine n solutions to the first oilfield model that optimize a target parameter of the first oilfield model; identify a second oilfield model; identify a set of parameter values used in the n solutions; use said set of parameter values to determine m solutions to the second oilfield model that optimize a different target parameter of the second oilfield model; identify a third oilfield model; identify a subset of said set used in the m solutions; select a value from said subset, said selected value optimizes another target parameter in the third oilfield model; determine an optimal solution to the first oilfield model, the second oilfield model, or both using the selected value as a constant; and cause the adjustment of oilfield equipment using one or more of said optimizations. These embodiments may be supplemented using one or more of the following concepts, in any order and in any combination: wherein the target parameter has a higher priority than said different target parameter, and said different target parameter has a higher priority than said another target parameter; wherein m is less than or equal to n; wherein the processor uses genetic algorithms to determine said n solutions and said m solutions; wherein the n solutions optimize the target parameter equally; and wherein the n solutions optimize the target parameter unequally but beyond a predetermined optimization threshold.

We claim:

1. A method for optimizing oilfield operations, comprising:
identifying a first oilfield model;
determining n solutions to the first oilfield model that optimize a target parameter of the first oilfield model;
identifying a second oilfield model;
identifying a set of parameter values used in the n solutions;
selecting from said set a value that optimizes a different target parameter in the second oilfield model;
determining an optimal solution to the first oilfield model using the selected value as a constant in said first oilfield model; and
adjusting oilfield equipment using one or more of said optimizations.

2. The method of claim 1, wherein the n solutions either optimize the target parameter equally or optimize the target parameter unequally but beyond a predetermined optimization threshold.

3. The method of claim 1, wherein the oilfield operations include upstream and downstream petroleum operations.

4. The method of claim 1, wherein selecting said value that optimizes the different target parameter comprises varying one or more other parameters of the second oilfield model.

5. The method of claim 1, wherein determining said n solutions comprises using a genetic algorithm.

6. The method of claim 1, wherein determining said optimal solution comprises varying one or more other parameters of the first oilfield model while holding said selected value constant.

7. The method of claim 1, wherein the target parameter has a higher priority than said different target parameter.

8. The method of claim 1, wherein the target parameter is revenue per barrel of oil equivalent (BOE) and the different target parameter is the degree of sound emissions.

9. A method, comprising:
identifying a first oilfield model;
determining n solutions to the first oilfield model that optimize a target parameter of the first oilfield model;
identifying a second oilfield model;
identifying a set of parameter values used in the n solutions;
using said set of parameter values to determine m solutions to the second oilfield model that optimize a different target parameter of the second oilfield model;
identifying a third oilfield model;
identifying a subset of said set used in the m solutions;
selecting a value from said subset, said selected value optimizes another target parameter in the third oilfield model;
determining an optimal solution to the first oilfield model, the second oilfield model, or both using the selected value as a constant; and
adjusting oilfield equipment using one or more of said optimizations.

10. The method of claim 9, wherein the target parameter has a higher priority than said different target parameter, and said different target parameter has a higher priority than said another target parameter.

11. The method of claim 9, wherein m is less than or equal to n.

12. The method of claim 9, wherein determining said n solutions and m solutions comprises using genetic algorithms

13. The method of claim 9, wherein the n solutions optimize the target parameter equally.

14. The method of claim 9, wherein the n solutions optimize the target parameter unequally but beyond a predetermined optimization threshold.

15. A computer-readable medium storing software which, when executed by a processor, causes the processor to:
identify a first oilfield model;
determine n solutions to the first oilfield model that optimize a target parameter of the first oilfield model;
identify a second oilfield model;
identify a set of parameter values used in the n solutions;
use said set of parameter values to determine m solutions to the second oilfield model that optimize a different target parameter of the second oilfield model;
identify a third oilfield model;
identify a subset of said set used in the m solutions;
select a value from said subset, said selected value optimizes another target parameter in the third oilfield model;
determine an optimal solution to the first oilfield model, the second oilfield model, or both using the selected value as a constant; and
cause the adjustment of oilfield equipment using one or more of said optimizations.

16. The system of claim 15, wherein the target parameter has a higher priority than said different target parameter, and said different target parameter has a higher priority than said another target parameter.

17. The system of claim 15, wherein m is less than or equal to n.

18. The system of claim 15, wherein the processor uses genetic algorithms to determine said n solutions and said m solutions.

19. The system of claim 15, wherein the n solutions optimize the target parameter equally.

20. The system of claim 15, wherein the n solutions optimize the target parameter unequally but beyond a predetermined optimization threshold.
